(19) United States
(12) Patent Application Publication
(10) Pub. No.: US 2020/0057354 A1
(43) Pub. Date: Feb. 20, 2020

(54) Methods of Electrically Controlling Photons Using Atomically Thin Transition Metal Dichalcogenide (TMDC) and Photonic Devices Including TMDC

(71) Applicant: NORTH CAROLINA STATE UNIVERSITY, Raleigh, NC (US)

(72) Inventors: Linyou Cao, Cary, NC (US); Yiling YU, Raleigh, NC (US)

(21) Appl. No.: 16/609,946

(22) PCT Filed: May 2, 2018
(86) PCT No.: PCT/US2018/030626

§ 371 Date: Oct. 31, 2019

Related U.S. Application Data
(60) Provisional application No. 62/500,636, filed on May 3, 2017.

(51) Int. Cl. G02F 1/313

(52) U.S. Cl. CPC G02F 1/313

(57) ABSTRACT

Provided herein are methods of electrically controlling photons using an atomically thin transition metal dichalcogenide layer. Further, provided are photonic devices and tunable waveguides including a transition metal dichalcogenide layer. The methods may include applying an electrical field to the transition metal dichalcogenide layer. The photonic devices and tunable waveguides may further include a first electrode, a second electrode, and an insulation layer. The insulation layer may extend between the first electrode and the transition metal dichalcogenide layer thereby electrically isolating the first electrode from the transition metal dichalcogenide layer.

### RELATED APPLICATION

This application claims the benefit of U.S. Provisional Patent Application Ser. No. 62/500,636, filed May 3, 2017, the disclosure of which is incorporated herein by reference in its entirety.

### STATEMENT OF GOVERNMENT SUPPORT

This invention was made with government support under grant number 1508856 awarded by the National Science Foundation. The government has certain rights to this invention.

### FIELD

The present invention relates to methods of electrically controlling photons using atomically thin transition metal dichalcogenide (monolayer or few layers) and photonic devices using the methods.

### BACKGROUND

Electrically gating photons with complementary metal-oxide-semiconductor (CMOS) compatible circuits may have the potential to revolutionize the photonics industry. It may enable the development of dynamic photonics with spatial and temporal resolutions comparable to that of state-of-art CMOS circuits. Of particular interest is the control of photons in the visible range as it may revolutionize the fields of imaging, cloaking, superlensing, and virtual reality. However, the electrical controlling photons may be very challenging because of difficulties in controlling refractive index. Photons typically cannot be directly manipulated by electric fields because of charge neutrality and may be controlled by virtue of light-matter interactions, including reflection, transmission, absorption, and scattering. As refractive index stands as a fundamental measure for light-matter interactions, to control photons may be in essence to control refractive index.

Some approaches have been reported to electrically tune refractive index, including plasma dispersion effect of free charges¹⁻⁵, electro-absorption effects (quantum confined stark effect⁶ and Keldysh effect^{4, 7}), and non-linear electro-optic effects such as Kerr^{s} or Pockels effects⁹. But these approaches may not provide satisfactory tuning efficiency, speed, spectral range, spatial resolution, and compatibility with CMOS circuits at the same time. For instance, the optical absorption of injected charge carriers may give rise to changes in the refractive index, but the density of the charge carriers that can be injected using conventional CMOS-gating is limited. This limits the tunability in refractive index at the scale of 0.1-1%^{1-2, 4, 10} or the tuning spectrum at mid-IR or GHz, THz frequencies³.

While ionic gating has been recently reported able to inject higher densities of charges, which gives rise to larger tunability in visible frequencies,¹¹⁻¹³ its nonlocal nature, inferior chemical stability, and intrinsically slow switching may limit the operation speed, footprint, and compatibility with CMOS circuits. Additionally, electro-absorption effects, including Keldysh and quantum confined stark effects,^{6-7, 14} have been reported able to induce change in optical absorption with the presence of electric fields in the vertical direction,^{6-7, 14} but as most of these works are in the infrared or even lower energy ranges, the tuning efficiency is often small (no more than few percent), or the structure is too bulky for integration with CMOS circuits.

### SUMMARY

According to some embodiments of the present invention, methods of electrically controlling photons using an atomically thin transition metal dichalcogenide layer are provided.

In some embodiments, the methods may further include applying an electrical field to the transition metal dichalcogenide layer. In some embodiments, applying the electrical field to the transition metal dichalcogenide layer may include connecting a first electrode and a second electrode to a voltage source. The first electrode may be electrically isolated from the transition metal dichalcogenide layer by an insulation layer that extends between the first electrode and the transition metal dichalcogenide layer, and the second electrode may be electrically connected to the transition metal dichalcogenide layer.

In some embodiments, the methods may further include injecting charge carriers (e.g., electrons, holes) into the transition metal dichalcogenide layer.

In some embodiments, the transition metal dichalcogenide layer may include MoS₂, WS₂, WSe₂, MoSe₂, MoTe₂, WTe₂, and/or an alloy thereof. In some embodiments, the transition metal dichalcogenide layer may include a monolayer or mutilayers including less than or equal to 10 layers.

According to some embodiments of the present invention, photonic devices may include a transition metal dichalcogenide layer, and a first electrode and a second electrode on the transition metal dichalcogenide layer. The second electrode may be electrically connected to the transition metal dichalcogenide layer. The photonic devices may also include an insulation layer extending between the first electrode and the transition metal dichalcogenide layer thereby electrically isolating the first electrode from the transition metal dichalcogenide layer.

In some embodiments, the transition metal dichalcogenide layer may include a monolayer or mutilayers including less than or equal to 10 layers. In some embodiments, the transition metal dichalcogenide layer may include MoS₂, WS₂, WSe₂, MoSe₂, MoTe₂, WTe₂, and/or an alloy thereof.

In some embodiments, the second electrode may directly contact the transition metal dichalcogenide layer.

In some embodiments, the transition metal dichalcogenide layer may include a first surface and a second surface opposite the first surface, and the first electrode may be on the first surface of the transition metal dichalcogenide layer, and the second electrode may be on the second surface of the transition metal dichalcogenide layer. In some embodiments, the second surface of the transition metal dichalcogenide layer may be configured to be exposed to an incident light.

In some embodiments, the transition metal dichalcogenide layer may include a first surface and a second surface opposite the first surface, and both the first electrode and the second electrode may be on the first surface of the transition metal dichalcogenide layer. In some embodiments, the second surface of the transition metal dichalcogenide layer may be configured to be exposed to an incident light.

In some embodiments, the transition metal dichalcogenide layer may include a first surface and a second surface that is opposite the first surface and may be configured to be exposed to an incident light, and the photonic devices may further include a reflection layer on the first surface of the transition metal dichalcogenide layer. In some embodiments, the reflection layer may include an insulating reflection layer (e.g., a metal oxide layer) and a conductive reflection layer (e.g., a metal layer) sequentially stacked on the first surface of the transition metal dichalcogenide layer. In some embodiments, the first electrode may be between the transition metal dichalcogenide layer and the reflection layer.

In some embodiments, the first electrode may include a plurality of the first electrodes that are spaced apart from each other, and/or the second electrode may include a plurality of the second electrodes that are spaced apart from each other.

According to some embodiments of the present invention, tunable waveguides may include a waveguide, a first electrode and a second electrode on the waveguide, and a transition metal dichalcogenide layer extending between the waveguide and the first and second electrodes. The transition metal dichalcogenide layer may be electrically connected to the second electrode. The tunable waveguides may also include an insulation layer extending between the first electrode and the transition metal dichalcogenide layer thereby electrically isolating the first electrode from the transition metal dichalcogenide layer.

In some embodiments, the first electrode and the second electrode may be spaced apart from each other along a longitudinal direction of the waveguide.

In some embodiments, the transition metal dichalcogenide layer may include a monolayer or mutilayers including less than or equal to 10 layers.

In some embodiments, the transition metal dichalcogenide layer may include MoS₂, WS₂, WSe₂, MoSe₂, MoTe₂, WTe₂, and/or an alloy thereof.

In some embodiments, the second electrode may directly contact the transition metal dichalcogenide layer.

### BRIEF DESCRIPTION OF THE DRAWINGS

FIG. 1 illustrates photonic devices according to some embodiments of the present invention.

FIG. 2 illustrates a photonic device including a reflection layer according to some embodiments of the present invention.

FIG. 3 illustrates a tunable waveguide according to some embodiments of the present invention.

FIG. 4 shows gated reflection and refractive index of monolayer WS₂.

FIG. 5 shows gating tunability of physical parameters in monolayer WS₂.

FIG. 6 shows bandgap renormalization and change in exciton binding energy in monolayer WS₂.

FIG. 7 shows a mechanism for a tunable refractive index.

FIG. 8 shows gating optical functionality according to some embodiments of the present invention.

FIG. 9 shows dependence in the reflection efficiency of the C exciton of monolayer WS₂ on electrical gating.

FIG. 10 shows spectral reflection collected from (a) monolayer MoS₂ and (b) monolayer WSe₂ under different gating voltages.

FIG. 11 shows fitted (dash lines) and measured (solid lines) spectral reflection of monolayer WS₂ under different gate voltages.

FIG. 12 shows the sum of the absorption coefficient ∫₀^{GeV}α(ω) at different gating voltages.

FIG. 13 (a) shows photoluminescence spectra of monolayer WS₂ under different gate voltages. FIG. 13 (b) shows I-V curve measurement of monolayer WS₂.

FIG. 14 shows fitted real (upper) and imaginary (lower) parts of dielectric function under different gate voltages.

FIG. 15 shows fitted (dash lines) and measured (solid lines) spectral reflection of monolayer WS₂ under different gate voltages.

FIG. 16 shows measured (solid lines) and fitted (dash lines) refractive index of monolayer WS₂ film, (upper) real and (lower) imaginary parts of the refractive index.

### DETAILED DESCRIPTION OF EMBODIMENTS

According to some embodiments of the present invention, methods of electrically controlling photons using atomically thin transition metal dichalcogenide (monolayer or few layer) and photonic devices using the methods are provided.

Transition metal dichalcogenide may include molybdenum sulfide (MoS2), tungsten sulfide (WS₂), molybdenum selenide (MoSe₂), tungsten selenide (WSe₂), molybdenum telluride (MoTe₂), and tungsten telluride (WTe₂), and/or an alloy thereof.

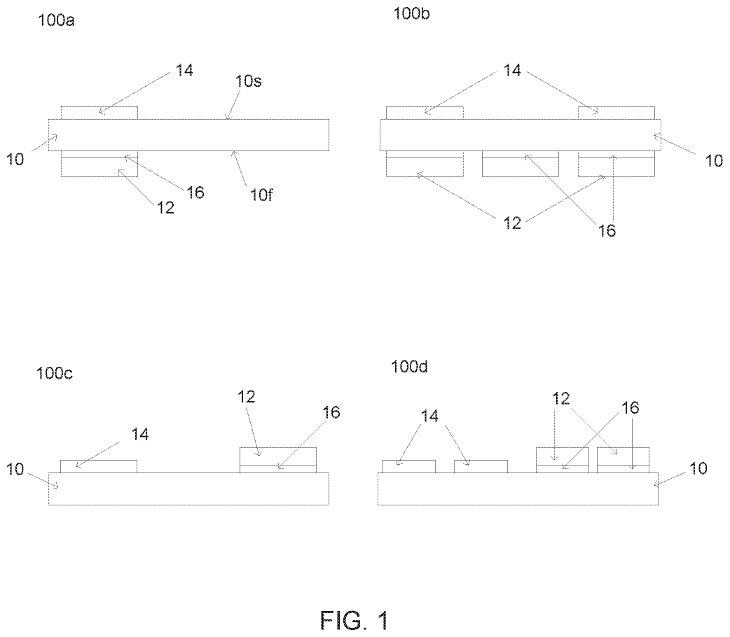

FIG. 1 illustrates four photonic devices, 100a, 100b, 100c and 100d, according to some embodiments of the present invention. Referring to FIG. 1, a photonic device may include a transition metal dichalcogenide layer 10 including a first surface 10f and a second surface 10s opposite the first surface 10f. One of the first surface 10f and the second surface 10s of the transition metal dichalcogenide layer 10 may be exposed to an incident light. The photonic device may also include a first electrode 12 and a second electrode 14. The first electrode 12 may be electrically isolated from the transition metal dichalcogenide layer 10 by an insulation layer 16, and the second electrode 14 may be electrically connected to the transition metal dichalcogenide layer 10. In some embodiments, the second electrode 14 may directly contact the transition metal dichalcogenide layer 10. It will be understood that the first electrode 12 may be considered as a gate electrode and the second electrode 14 may be considered as a source/drain electrode.

The transition metal dichalcogenide layer 10 may be a thin layer. For example, the transition metal dichalcogenide layer 10 may be a 2 dimensional monolayer, and may also be few layers. In some embodiments, the transition metal dichalcogenide layer 10 may be mutilayers including less than or equal to 10 layers. The transition metal dichalcogenide layer 10 may include MoS₂, WS₂, WSe₂, MoSe₂, MoTe₂, WTe₂, and/or an alloy thereof. The first and second electrodes 12 and 14 may include a conductive material (e.g., metal, metal nitride, a conductive metal oxide). In some embodiments, the first and second electrodes 12 and 14 may include transparent materials. In some embodiments, the first electrode 12 may include a material different from the second electrode 14. For example, the first electrode 12 may include a GaN layer (e.g., a doped GaN layer), and the second electrode 14 may include a Ti/Au layer. The insulation layer 16 may include an insulation material (e.g., semiconductor oxide, metal oxide). For example, the insulation layer 16 may include HfO₂.

Referring to the photonic device 100a in FIG. 1, in some embodiments, the first and second electrodes 12 and 14 may be on the first surface 10f and the second surface 10s, respectively. The second surface 10s may be exposed to an incident light. In some embodiments, the second electrode 14 may cover only a portion of the second surface 10s such that a majority of the surface area is exposed to an incident light. However, the present invention is not limited thereto. In some embodiments, the second electrode 14 may include a transparent material and may cover the entire second surface 10s. In some embodiments, the first electrode 12 may include several first electrodes 12, and the second electrode 14 may include several second electrodes 14. For example, a photonic device may include three first electrodes 12 and two second electrodes 14 (See the photonic device 100b in FIG. 1).

Still referring to FIG. 1, in some embodiments, the first and second electrode 12 and 14 may be on the same surface of the transition metal dichalcogenide layer 10 (See the photonic devices 100c and 100d in FIG. 1). One of opposing surfaces of the transition metal dichalcogenide layer 10 may be exposed to an incident light. In some embodiments, a surface on which the first and second electrode 12 and 14 are disposed is exposed to an incident light.

As appreciated by the inventors, the photonic devices of FIG. 1 may be used to electrically control photons of the transition metal dichalcogenide layer 10. Photons may be controlled by applying an electrical field to the transition metal dichalcogenide layer 10 using the first and second electrode 12 and 14. In some embodiments, photons of the transition metal dichalcogenide layer 10 may be controlled by injecting charge carriers (e.g., holes, electrons) to the transition metal dichalcogenide layer 10 through the second electrode 12. By controlling photons of the transition metal dichalcogenide layer 10, the photonic devices of FIG. 1 may change transmission, reflection, absorption, scattering and/or guiding of a light incident on the transition metal dichalcogenide layer 10, for example, by electrically switching optical characteristics of the transition metal dichalcogenide layer 10.

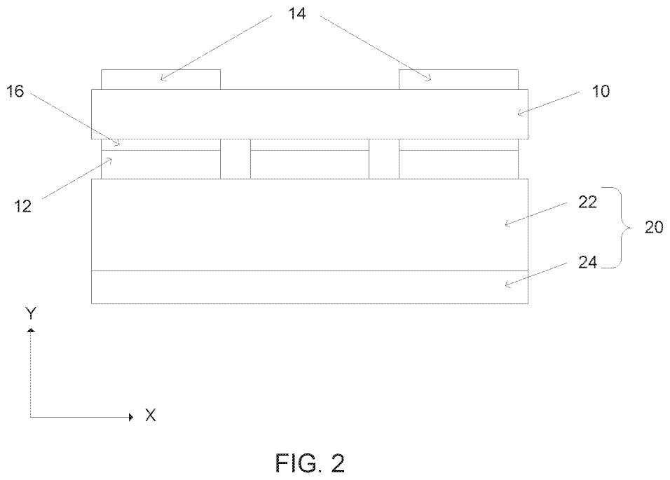

FIG. 2 illustrates a photonic device including a reflection layer according to some embodiments of the present invention. Referring to FIG. 2, a photonic device may include a reflection layer 20. Although FIG. 2 only illustrates the photonic device 100b including the reflection layer 20, the reflection layer 20 may be included in any of the photonic devices illustrated in FIG. 1. The reflection layer 20 may be on a surface that is opposite a surface on which a light is incident. The reflection layer 20 may include an insulating reflection layer 22 (e.g., a metal oxide layer) and a conductive reflection layer 24 (e.g., a metal layer) sequentially stacked on the transition metal dichalcogenide layer 10. For example, the insulating reflection layer 22 may include Al₂O₃, and the conductive reflection layer 24 may include Ag. The insulating reflection layer 22 may induce multiple reflections in the insulating reflection layer 22 to enhance reflection of an incident light. The conductive reflection layer 24 may reflect an incident light like a mirror. In some embodiments, the insulating reflection layer 22 may have a thickness in a Y direction about 700 nanometer (nm).

Still referring to FIG. 2, for example, the first electrode 12 may have a width in a X direction of about 300 nm and may have a thickness in the Y direction of about 140 nm. In some embodiments, the insulation layer 16 may have a thickness in the Y direction of about 10 nm. In some embodiments, two adjacent first electrodes 12 may be spaced apart from each other in the X direction by about 50 nm.

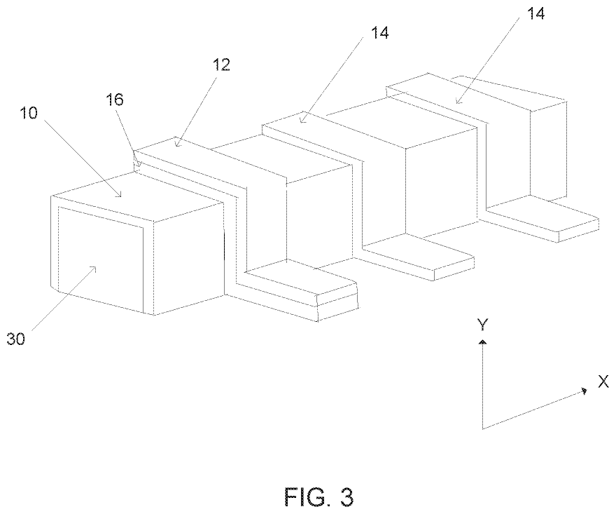

FIG. 3 illustrates a tunable waveguide according to some embodiments of the present invention. Referring to FIG. 3, the tunable waveguide may include a waveguide 30, first and second electrodes 12 and 14, and a transition metal dichalcogenide layer 10 extending between the waveguide 30 and the first and second electrodes 12 and 14. The first electrode 12 may be electrically isolated from the transition metal dichalcogenide layer 10 by an insulation layer 16 that extends between the first electrode 12 and the transition metal dichalcogenide layer 10. The second electrode 14 may be electrically connected to the transition metal dichalcogenide layer 10. In some embodiments, the second electrode 14 may directly contact the transition metal dichalcogenide layer 10.

In some embodiments, the tunable waveguide may include several first electrodes 12 and several second electrodes 14 as illustrated in FIG. 3. The first electrodes 12 and the second electrodes 14 may be spaced apart from each other along a longitudinal direction of the tunable waveguide (i.e., a X direction). Although FIG. 3 shows only a single first electrode 12, the tunable waveguide may include several first electrodes 12.

According to some embodiments of the present invention, a refractive index of transition metal dichalcogenide (TMDC) layer may be substantially tuned by >60% in the imaginary part and >20% in the real part around exciton resonances using CMOS-compatible electrical gating. This range of tunablility may be rooted in the dominance of excitonic effects in the refractive index of the thin layer (e.g., a monolayer, multilayers including less than or equal to 10 layers) of transition metal dichalcogenide (TMDC) and the strong susceptibility of the excitons to the influence of injected charge carriers. The tunability may result from the effects of injected charge carriers (e.g., electrons) to broaden the spectral width of excitonic interband transitions and to facilitate the interconversion of neutral and charged excitons. Other effects of the injected charge carriers, such as renormalizing bandgap and changing exciton binding energy, may play relatively negligible roles. As appreciated by the inventors, atomically thin layers (e.g., monolayers) of TMDC layers, when combined with photonic structures, may enable the efficiencies of optical absorption (reflection) to be tuned from 40% (60%) to 80% (20%) due to the range of tunability of refractive index. Accordingly, this invention may pave the way towards the development of field-effect photonics in which the optical functionality can be controlled with CMOS circuits.

This large tunability may be achieved by leveraging on the strong excitonic effects of the monolayers¹⁵ and the high susceptibility of the excitons to the influence of free charge carriers. The inventors also elucidated that the tunability in refractive index may be due to the effects of the injected charge carriers in broadening the spectral width of excitonic transitions and facilitating the interconversion of neutral and charged excitons. In contrast, other effects of the injected charge carriers, such as renormalizing the bandgap and changing the exciton binding energy, may play relatively negligible roles. Although some previous studies have reported electrical tunability in the light absorption and emission of TMDC monolayers,¹⁶⁻²¹ the present invention quantitatively demonstrated the tunability in refractive index and unambiguously elucidated the underlying physics. Additionally, the inventors used a design to illustrate that, when combined with optical resonant structures, the tunability of refractive index in the atomically thin monolayers may enable substantial change in light reflection and absorption.

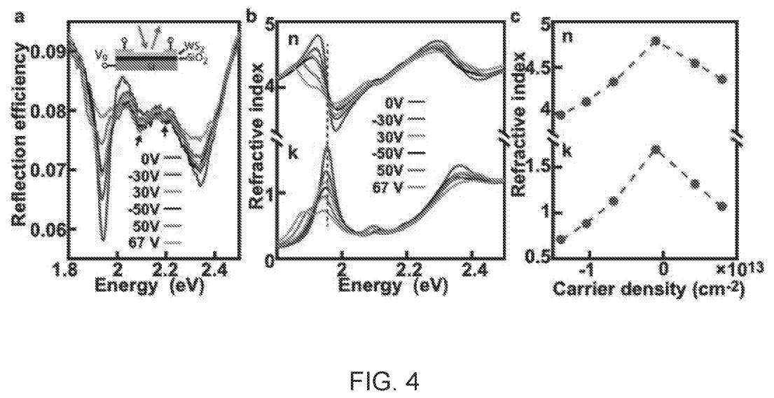

The inventors examined the spectral reflectance (the intensity ratio of the light reflected from the monolayer and the light reflected from a mirror) of TMDC monolayers under electrical gating. FIG. 4 shows gated reflection and refractive index of monolayer WS₂. FIG. 4(a) shows reflection spectra of monolayer WS₂ at different gating voltages and schematic illustration for the measurement configuration. The two arrows point out the two excited states of the A exciton, 2S and 3S. FIG. 4(b) shows fitted real part n and imaginary part k of refractive index with different gating voltages. FIG. 4(c) shows the peak value of the real part (at around 1.92 eV) and the imaginary part (at around 1.95 eV) as a function of carrier densities.

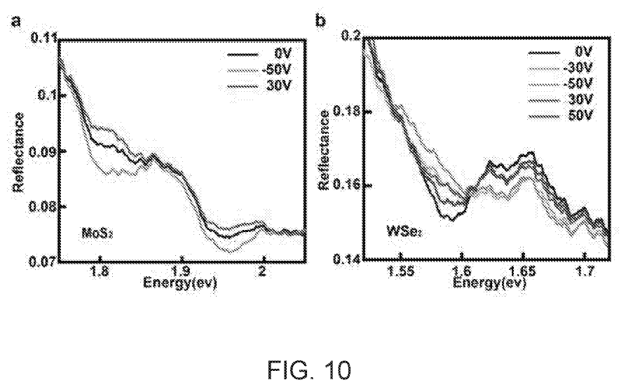

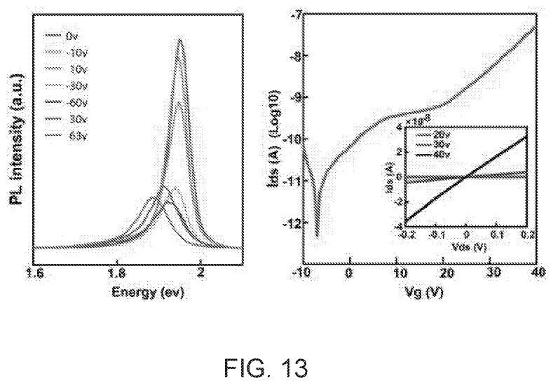

The monolayers (obtained from 2D layer) may be grown on degenerately doped Si substrates with thermally grown silicon oxide (SiO₂/Si) using chemical vapor deposition (CVD) processes. The source and drain electrodes (5 nm Ti/50 nm Au) may be fabricated on top of the monolayer using standard e-beam lithography and metallization procedures. The electrodes can form Ohmic contact with the monolayers (See FIG. 13(b)). In some experiments, the Si substrate is used as the gate and identical potentials are applied to the source and drain electrodes. FIG. 4(a) shows the spectral reflection collected from monolayer WS₂ under different gating voltages. The reflection of the A exciton (˜1.95 eV) shows substantial variation with the gating voltage, but the B (˜2.35 eV) and C excitons (˜2.70 eV, FIG. S1) show much less or even negligible variation. The appearance of the gated variation only at the excitonic peaks suggests that this is not caused by the plasma dispersion effect of free charge carriers, which would give rise to changes over a broad spectral range. Similar gating tunability in reflectance can also be observed at monolayer MoS₂ and WSe₂ (See FIG. 10).

The inventors obtained refractive index from the measured spectral reflection using a Kramers-Kronig constrained analysis. Basically, the inventors fitted the complex dielectric function ε=ε₁+iε₂ of the monolayer as a sum of contribution from multiple Lorentz oscillators²²⁻²³:

$$ɛ ( E ) = {ɛ}_{∞} + {\sum }_{j} \frac{{f}_{j}}{{E}_{j}^{2} - {E}^{2} - iE {γ}_{j}} \qquad ( 1 )$$

where ε_{∞} is the high frequency dielectric constant, Eⱼ and γⱼ are the resonant energy and damping factor of the jth oscillator, respectively. fⱼ is a phenomenal parameter involving contribution from transition matrix element, density of states, and excitonic effects.

Additionally, the inventors fitted the reflection of the monolayer on top of SiO₂/Si substrates using a model for the reflection of multilayer structures as²⁴

$$R = {\vert r \vert}^{2} = {\vert \frac{{ρ}_{1} + {ρ}_{1} {e}^{- i 2 {k}_{1} {d}_{1}} + {ρ}_{1} {ρ}_{2} {ρ}_{3} {e}^{- i 2 {k}_{2} {d}_{2}} + {ρ}_{3} {e}^{- i 2 ( {k}_{1} {d}_{1} + {k}_{2} {d}_{2} )}}{1 + {ρ}_{2} {ρ}_{1} {e}^{- i 2 {k}_{1} {d}_{1}} + {ρ}_{2} {ρ}_{3} {e}^{- i 2 {k}_{2} {d}_{2}} + {ρ}_{1} {ρ}_{3} {e}^{- i 2 ( {k}_{1} {d}_{1} + {k}_{2} {d}_{2} )}} \vert}^{2} \qquad ( 2 )$$

where ρᵢ=(n₁−n₀)/(n₁+n₀), ρ₂=(n₂−n₁)/(n₁+n₂), and β₃=(n₃−n₂)/(n₂+n₃). n₀, n₁, n₂, and n₃ are the refractive index of air, the monolayer, SiO₂, and Si, respectively. k₁ and k₂ are the wavenumber in the monolayer and SiO₂ as k₁=n₁2π/λ and k₂=n₂2π/λ. d₁ and d₂ are the thickness of the monolayer and the SiO₂. The refractive index of the monolayer n₂ can be correlated to the fitted dielectric function ε as n₂²=ε.

In order to get accurate determination of the dielectric function ε, the Kramers-Kronig constrained analysis may require information in the full spectral range, but the measured spectral reflection only cover the range of 1.8-2.5 eV. To address this issue, the contribution from the oscillators in lower energy ranges may be ignored as it is expected to be weak for the refractive index in the visible range. However, the contribution from the oscillators at higher energy ranges should be considered. The dielectric function of the monolayer at the higher energy ranges may be similar to that of bulk counterparts, and the dielectric function of the bulk counterparts, which is available in reference²⁵, may be used to correct the oscillators of the monolayers in the higher energy range. This strategy has been previously demonstrated able to give rise to reasonably accurate dielectric function of TMDC monolayers from spectral reflectance²⁶.

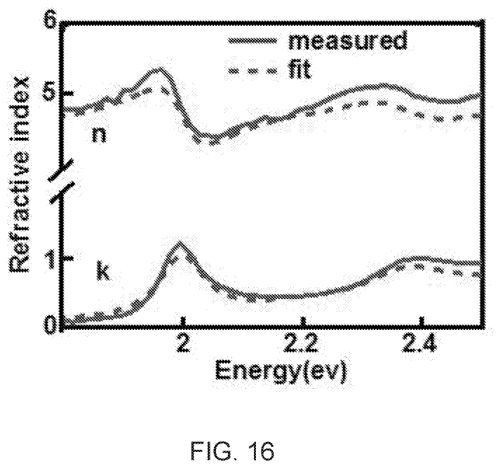

The inventors have also confirmed that the refractive index obtained using this strategy is indeed consistent with that measured from spectral ellipometry, a standard characterization techniques for dielectric functions (See FIG. 16). More detailed description about the fitting process will be discussed in the “Experimental Method” provided below. Three major oscillators are involved in the measured spectral reflection, including the neutral A exciton (A₀), the charged A trion (A₋ or A₊), and the B exciton. The resonant energy Eⱼ and damping factor γⱼ for each of the oscillators can be found out from the measured spectral reflection (See FIG. 4(a)). There are another two small oscillators corresponding to the excited states (2S and 3S) of the A exciton as indicated by the black arrows in FIG. 4(a),²⁷ but they can be ignored due to trivial contribution.

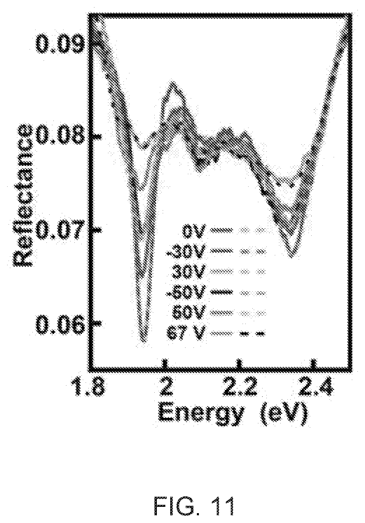

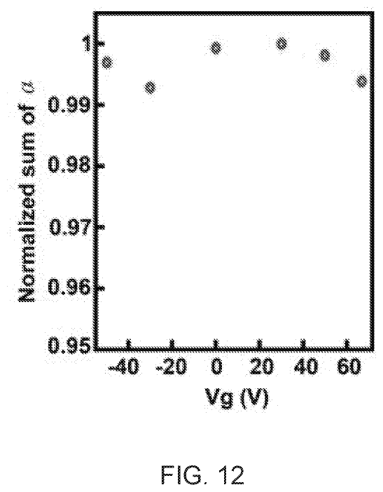

FIG. 4(b) shows the refractive index obtained from the analysis. The fitted reflection spectra match the experimental results very well (See FIG. 11). Additionally, the sum rule holds for the fitted reflective index under all the different gating voltages²⁸ as the integration of the fitted absorption coefficient α(ω) over the full spectrum range (up to 6 eV) always gives rise to similar values regardless the gating voltage (See FIG. 12). All these further support the validity of the fitting method. The refractive index at the frequencies around the A exciton shows substantial tunability, the real part tuned from 4.80 to 3.97 and the imaginary part from 1.7 to 0.7 when the gating voltage V_{g} is changed from 0 to 67 V. This is two orders of magnitude higher than some conventional methods for tuning the refractive index in the visible range by electrical gating.¹⁰ It should be noted that the maximal tunability of the real and imaginary parts may appear at different frequencies, for example, 1.95 eV for the imaginary part and around 1.92 eV for the real part. This may be rooted in the conjugation nature of the real and imaginary parts of dielectric functions. To further illustrate the tunability, the inventors plotted the real part of the refractive index at 1.92 eV and the imaginary part at 1.95 eV as a function of the density of charge carriers in FIG. 4(c). The charge density is estimated using the capacitor model Q=Cₒₓ(V_{g}−Vₜₕ), in which Cₒₓ is the oxide capacitance, V_{g} is the gate voltage, and Vₜₕ is the threshold voltage for charge neutrality in the monolayer that the inventors found to be around −7V from PL¹⁷ and I-V measurements (See FIG. 13). Both the real and imaginary parts of the refractive index show a maximum at the point of charge neutrality and decrease with the density of charge carriers (either electrons or holes) increasing.

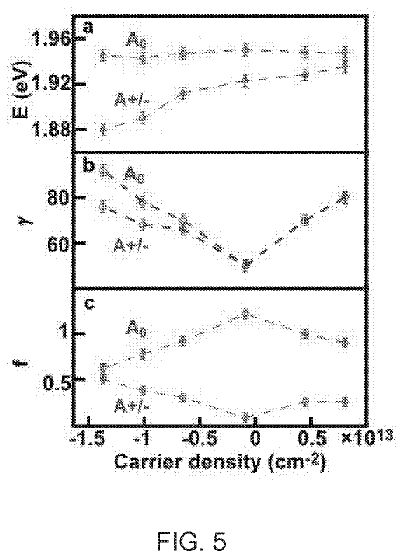

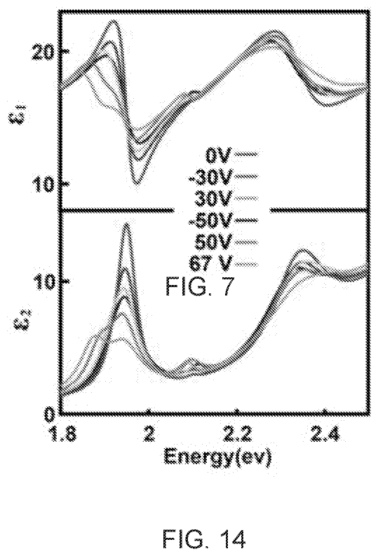

FIG. 5 shows gating tunability of physical parameters in monolayer WS₂. FIG. 5(a) shows optical bandgap E, FIG. 5(b) shows damping factor γ, and FIG. 5(c) shows f that represents the oscillation strength of the neutral (A₀) and charged (A_{+/—}) excitons. The error bar given in FIG. 5 represents the error in fitting the measured spectral reflectance. The observed tunability in refractive index can be mainly correlated to the gated variation in the absorption of the neutral A exciton (A₀). This is evidenced by the imaginary part of the dielectric function ε₂ (See FIG. 14), which is proportional to optical absorption and may uniquely determine the real part of the dielectric function via the Kramers-Kronig relationship.²³ The fitting result for ε₂ indicates that the absorption of the neutral A exciton (A₀) shows substantial variation with electrical gating. For the convenience of discussion, the inventors focused on the on-resonance absorption of A₀ that is proportional to ε₂=f_{A0}/(E_{A0} □γ_{A0}). The resonant frequency E_{A0} does not change much with the gating voltage (See FIG. 5(a)). Therefore, the observed tunability in refractive index may be dictated by the variation of f_{A0} and γ_{A0} under electrical gating. To better illustrate this notion, the inventors plotted γ_{A0} (obtained from FIG. 4(a)) and f_{A0} (obtained from the Kramers-Kronig constrained analysis with eq. (1)) as a function of charge carrier densities in FIGS. 5(b) and 5(c). The f and γ of the charged A exciton (A_{+/-}) are also plotted in FIG. 5 as reference.

The physics underlying the gated variation of f_{A0} and γ_{A0} may be better understood through analysis for the effect of the injected charge carriers. Generally, the injected charge carriers may affect the optical properties of low-dimensional semiconductor materials through three major physical mechanisms: Pauli blocking, Coulomb scattering, and dielectric screening. The Pauli blocking effect is expected to be negligible for the neutral A exciton in monolayer WS₂, because the injected electrons tend to fill in a lower-lying spin-orbit-split level of the conduction band that is not involved in the absorption of the neutral A exciton.¹⁶ The Coulomb scattering, through which excitons interact with the injected charge carriers, may broaden the spectral width of excitonic absorption by enhancing the dephasing rate and also facilitate the formation of charged excitons. The screening of Coulomb interactions may lead to bandgap renormalization and change in the exciton binding energy.^{27, 29-30} The bandgap renormalization and the change in exciton binding energy can be estimated from Raman measurements.

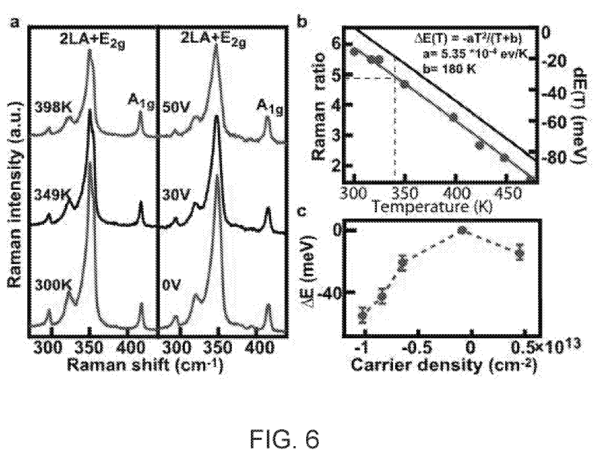

FIG. 6 shows bandgap renormalization and change in exciton binding energy in monolayer WS₂. FIG. 6(a) shows comparison of Raman spectra of monolayer WS₂ at different temperatures (left) and different gating voltages (right). The intensity is normalized to that of the A_{1g} peak. FIG. 6(b) shows the measured (dots) and fitted (line) Raman intensity ratio as a function of the temperature. The black curve is the calculated bandgap shift of the monolayer as a function of temperature, in which the bandgap at 300 K is used as the reference. The dashed lines indicate one Raman intensity ratio measured at the monolayer under electrically gating. FIG. 6(c) shows the estimated bandgap renormalization of monolayer WS₂ as a function of the density of charge carriers. The intensity ratio of the two characteristics Raman peaks of monolayer WS₂, E_{2g}/2LA(M) and A_{1g}, decreases with the charge carrier density increasing (See FIG. 6(a)). This can be correlated to the bandgap renormalization as the intensity of the E_{2g}/2LA(M) peak is related with the band structure due to the involvement of double resonances.³¹

The inventors could estimate the amplitude of the bandgap renormalization by comparing the Raman spectra measured at different gating voltages to those collected under different temperatures. This is because the Raman intensity ratio decreases with the temperature increasing, and the temperature dependence is similar to the dependence of the intensity ratio on the gating voltage (See FIG. 6(a)). Briefly, the inventors identified the temperature under which the Raman intensity ratio is comparable to what observed at specific gating voltages, and then estimate the bandgap renormalization based on a well-established temperature-bandgap correlation (See FIG. 6(b)).³² For simplicity, the effect of temperatures on the exciton binding energy is ignored, which was reasonable given the relative small temperature change in the experiments (300K to 450K). The estimated bandgap renormalization ΔE_{g} (using the bandgap at the gating voltage of 0V as reference) was plotted as a function of the density of charge carriers in FIG. 6(c). With the information of bandgap renormalization ΔE_{g}, the inventors derived the change in exciton binding energy ΔEₑₓ from the change in the optical bandgap ΔEₒₚₜ as ΔEₒₚₜ=ΔE_{g}−ΔEₑₓ. For the neutral A exciton, ΔEₑₓ is approximately the same as ΔE_{g} since the optical bandgap shows very mild variation (<7 meV) with the gating voltage (FIG. 2a). By the same token, the inventors may also estimate ΔEₑₓ of the charged A exciton (See Table 1).

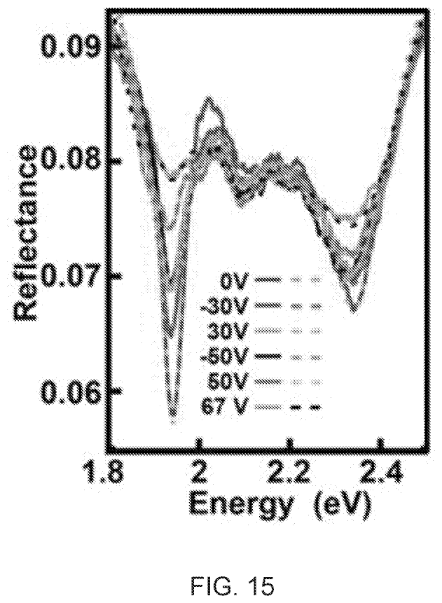

Coulomb scattering may be the major mechanism for the gated variation in the damping factor γ. The inventors could find out the mechanism governing the gated variation off through fitting the dielectric function with a model of Wannier excitons in fractional dimension space. The fractional dimensional space model has previously been established to describe the optical properties of quantum wells.³³⁻³⁸ It treats highly anisotropic excitons in low-dimensional structures to be isotropic in a fractional-dimensional space, and defines an effective dimensionality d based on the excitonic binding energies in bulk materials R and the low-dimensional structure Eₑₓ as d=1+2(R/Eₑₓ)^{0.5}. One advantage of the fractional dimension space model lies in its capability to quantitatively evaluate the contribution of excitonic effect, which is realized by introducing the effective dimensionality to the calculation of joint density of states. According to the fractional dimension space model, the complex dielectric function εⱼ at an arbitrary energy E contributed by one excitonic transition can be written as εⱼ=Sⱼ·Gⱼ, where Sⱼ is a parameter representing the transition probability and is an effective joint density of state in which the excitonic effect is represented by the effective dimensionality d.³³⁻³⁸ More specifically,

$${S}_{j} = F {\vert {p}_{cv} \vert}^{2} \\ {G}_{j} = \frac{{R}^{d / 2 - 1}}{{( E + i {γ}_{j} )}^{2}} [ {g}_{d} ( ξ ( E + i {γ}_{j} ) ) + {g}_{d} ( ξ ( - E - i γ ) ) - {g}_{d} ( ξ ( 0 ) ) ] \\ … \\ {g}_{d} ( ξ ) = \frac{2 π Γ ( ( d - 1 ) / 2 + ξ )}{{Γ ( ( d - 1 ) / 2 )}^{2} Γ ( 1 - ( d - 1 ) / 2 + ξ ) {ξ}^{d - 2}} [ cot π ( ( d - 1 ) / 2 - ξ ) - cot π ( d - 1 ) ] \qquad ( 3 )$$

where F is a constant prefactor, p_{vc} is the matrix element for the interband transition, μ is the reduced effective mass of electrons, e and m₀ are the charge and mass of free electrons, ε₀ and ℏ are the vacuum permittivity and the Planck's constant, Γ( ) is the gamma function, ξ( ) is a function related with the electronic bandgap E_{g} and R as ξ(z)=[R/(E_{g}−z)]². The exciton binding energy in monolayer and bulk WS₂ is set to be 0.7 eV³⁹⁻⁴⁰ and 0.055 eV²⁵, respectively. The other parameters, including the effective dimensionality d, electronic bandgap E_{g}, damping factor γ can be obtained from either the known binding energy, the experimental measurement, or the preceding discussion. The inventors used the eq. (3) to fit the dielectric function. Basically, the inventors first calculated Gⱼ using the known parameters and then fit the value of Sⱼ to match the measured reflection spectra (See FIG. 15).

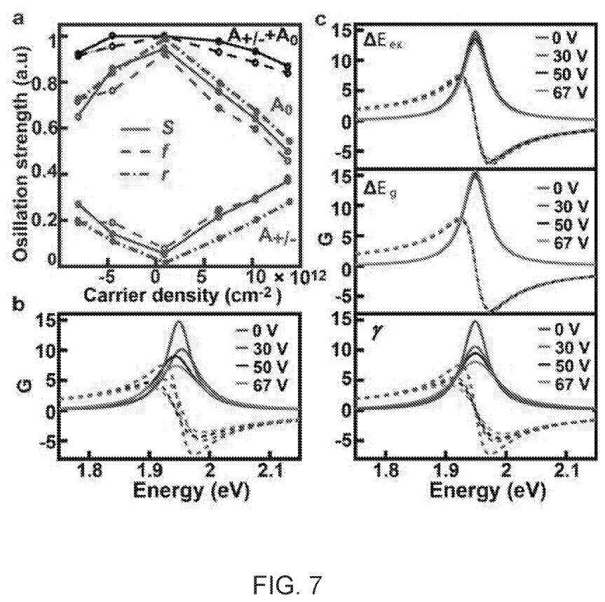

FIG. 7 shows a mechanism for the tunable refractive index. FIG. 7(a) shows fitting results for S and f of the neutral and charged A excitons as function of charge carrier densities. The black solid and dashed lines indicate the sum of the values for both neutral and charged excitons. The calculated fractions of the neutral and charged excitons r are also given. FIG. 7(b) shows calculated G for the neutral A exciton with different gating voltages. FIG. 7(c) shows calculated G of the neutral A exciton as a function of (upper) change in exciton binding energy, (middle) bandgap renormalization, change in the damping factor γ. The spectra in the upper and middle panels are artificially shifted to align the peak position for the convenience of comparison.

The fitting result indicates that the gated variation in f_{A0} mainly results from the interconversion of neutral and charged A excitons. FIG. 7(a) shows the fitted Sⱼ for the neutral (A₀) and charged (A_{+/-}) excitons at different carrier densities. Useful physical insight may be obtained by comparing Sⱼ to fⱼ as shown in FIG. 7(a). For the convenience of comparison, all the results are normalized to the sum of the values for both neutral and changed excitons (S_{A0}+S_{A+/-} and f_{A0}+f_{A+/-}) at the gating voltage of 0V. The Sᵢ and fⱼ show very similar dependence on the charge carrier density. This indicates that the enhancement by excitonic effects to the oscillation strength, which is involved in fᵢ but not in Sⱼ, does not change much with the gating voltage. The variation in fⱼ under electrical gating mainly results from change in the transition matrix element p_{vc}, instead of change in the excitonic effect. Additionally, the sum of the Sⱼ for the neutral and charged excitons together remains to be reasonably constant regardless the gating voltage. This suggests that the interband transitions of the neutral and charged excitons are competing processes that involve the same ground state. The change of the Sⱼ for the neutral and charged excitons with gating voltages results from the interconversion between the neutral and charged excitons, which is indicated by the redistribution of the transition matrix element p_{vc} among the neutral and charged excitons.

The correlation of gated variation in fⱼ to the interconversion of neutral and charged excitons may be further supported by the thermal equilibrium distribution of the excitons. The inventors used the negatively charged exciton as an example to illustrate this notion. The interconversion of the neutral and negatively charged exciton can be written as A₀+e↔A−. Following what has been previously studied,⁴¹ the inventors assumed that, in the temperature and photoexcitaton range of the experiments, the monolayer including the neural and charged excitons behaves as a two-level system in equilibrium. The thermal equilibrium distribution of the neutral and charged excitons may be dictated by the chemical potential of the injected electrons and the binding energy of the charged exciton E_{b}^{A-}. The chemical potential of a two-dimensional ideal fermion gas can be written as ξ=k_{B}T ln(e^{E}^{_{F}}^{/k}^{_{B}}^{T}1), where k_{B} and T are the Boltzmann constant and temperature, respectively. E_{F} is the Fermi energy of the injected electrons at the conduction band and can be calculated with E_{F}=πℏ²nₑ/(2mₑ), where nₑ and mₑ are the density and effective mass of the injected electrons, and the constant of 2 stands for valley degeneracy of the monolayer.⁴² The ratio between the densities of the neutral (n_{A0}) and charged (n_{A-}) excitons under thermal equilibrium is a function of the binding energy of charged exciton

$$\frac{{n}_{A 0}}{{n}_{A -}} = 4 {e}^{( {E}_{b}^{A -} - ξ ) / {k}_{B} T} ,$$

where the factor 4 is the degeneracy ratio of the neutral and charged excitons.⁴¹ Therefore, the fractions of the neutral and charge excitons are defined as r_{A0}=n_{A0}/(n_{A0}+n_{A-}) and r_{A-}=n_{A-}/(n_{A0}+n_{A-}).

The inventors could estimate the binding energy E_{b}^{A-} from the measured optical bandgaps of the neural (E_{A0}) and charge (E_{A-}) excitons and the binding energy as E_{b}^{A-}=E_{A0}−E_{A-}−E_{F}. Similar analysis can be performed for the positively charge A exciton (A₊). With all the information, the inventors could calculate the fractions r_{A0} and r_{A-} as a function of the density of injected charge carriers (See Table 1 for the parameters used in the calculation). The calculation results are plotted in FIG. 7(a). It shows reasonable consistence with the fⱼ, further indicating the gated variation off can be mainly ascribed to the interconversion of the neutral and charged excitons.

The fitting result confirms that the damping factor γ may be important for the observed tunability in refractive index. It also indicates that the change in excitonic binding energy ΔEₑₓ and the bandgap renormalization ΔE_{g} may play relatively negligible roles. These variables are all included in the parameter Gⱼ but not Sⱼ. The inventors examined Gⱼ as a function of each of the variable. The change in the damping factor γ dominates the variation in Gⱼ, while the change in binding energy ΔEₑₓ (represented by change in the effective dimensionality d) and the bandgap renormalization ΔE_{g} (represented by change in the electronic bandgap E_{g}) may have relatively minor effects (See FIG. 7(c)). Intuitively, this result is understandable as the ΔEₑₓ and ΔE_{g} are more than one order of magnitude smaller than the exciton binding energy and bandgap, respectively.

In conclusion, the inventors have demonstrated large gating tunability in the refractive index (>60% in the imaginary part and >20% in the real part) around exciton resonances of atomically thin TMDC monolayers. Even larger tunability can be achieved with optimization in the device fabrication. Additionally, the inventors have elucidated that the tunability mainly results from the spectral broadening (γ) and the interconversion of the neutral and charged excitons caused by the injected charge carriers. In contrast, other effects of the injected charge carriers, including bandgap renormalization and change in exciton binding energy, may play relatively negligible roles. The result may provide new insight into some fundamental optical properties of 2D TMDC materials. For instance, changing the substrate and dielectric environment of 2D TMDC materials, which is expected to change the screening of Coulomb interactions, may not affect the dielectric function of 2D TMDC materials much¹⁵ unless the changing may induce substantial change in the exciton spectral width or the doping to the materials.⁴³ More importantly, this result may open up a new age of field-effect photonics whose optical functionality can be electrically controlled in ways similar to that of state-of-art CMOS circuits. As the intrinsic optical response of 2D TMDC materials is weak due to the atomically thin dimension, the development of field-effect photonic devices for practical applications would require substantial enhancement in the optical response, and this can be achieved by leveraging on the power of optical resonance.⁴⁴

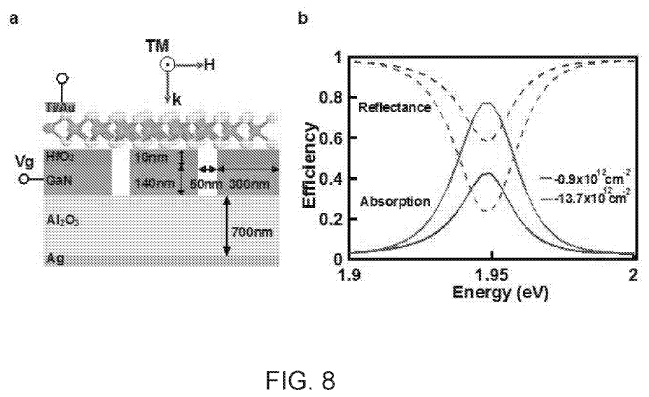

To illustrate this notion, the inventors have designed a GaN based grating structure on Al₂O₃ with a monolayer WS₂ covered on the top and a silver mirror at the bottom as illustrated in FIG. 8(a). FIG. 8 shows gating optical functionality. FIG. 8(a) provides an illustration of configuration of an example photonic device. FIG. 8(b) shows the simulated absorption efficiency (solid line) and reflectance (dash line) corresponding to different electron injection induced by gate voltages.

The GaN layer is heavily doped and serves as back gate with a thin layer HfO₂ on top as insulating gate dielectric layer. The top electrode Ti/Au is directly deposited on top of the monolayer WS₂. The inventors' calculation indicates that the absorption and reflectance can be electrically tuned in the range of 40-80% when the charge carrier is tuned from −0.9×10¹² cm⁻² to −13.7×10¹² cm⁻².

### Experimental Method

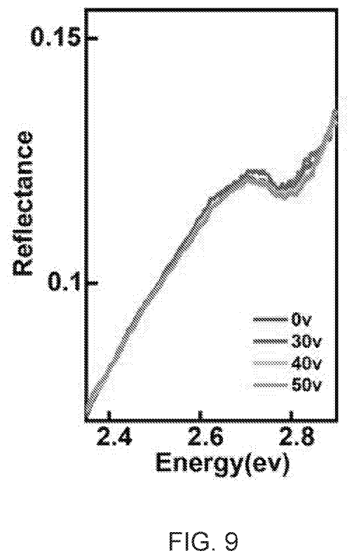

The Raman and PL measurement were carried out at Horiba Labram HR800 system with incident wavelength of 532 nm. The reflection spectra were collected using a home-built setup that consists of a confocal microscope (Nikon Eclips C1) connected with a monochromator (SpectraPro, Princeton Instruments) and a detector (Pixis, Princeton Instruments). A broadband Halogen lamp was used as incident light for the reflection measurements. The reflectance from the sample is calculated by normalizing the light reflected from sample with respect to the light reflected from a dielectric mirror under the same configuration. FIGS. 9-16 show results of the experiments. In FIG. 11, the dielectric function is fitted using the multi Lorentzian model. In FIG. 12, the result is normalized with respect to the sum of absorption coefficient at 0V. FIG. 13 (b) is I-V curve of drain-source electrodes under different back gate voltages (Vg). The linear relation indicates good Ohmic contacts. In FIG. 15, the dielectric function is fitted using the Fractional dimensional space model.

### Fitting Dielectric Function Using a Multi-Lorentzian Model

In order to get accurate determination of the dielectric function e, the Kramers-Kronig constrained analysis may require information in the full spectral range, but the measured spectral reflection covers the range of 1.8-2.5 eV. To address this issue, the inventors ignored the contribution from the oscillators in lower energy ranges as it is expected to be weak for the refractive index in the visible range. However, the contribution from the oscillators at higher energy ranges should be considered. The inventors assumed that the dielectric function of the monolayer at the higher energy ranges is similar to that of bulk counterparts, and use the dielectric function of the bulk counterparts, which is available in reference²⁵, to correct the oscillators of the monolayers in the higher energy range. Multiple oscillators are set with equal space of 0.1 eV and almost equal damping constant 0.3 eV. The oscillation strength of these oscillators is fitted to match the dielectric function of bulk WS₂ in the UV frequency range. The high frequency Lorentzian oscillators are fitted up to 6 ev. The contribution from even higher frequency (larger than 6 ev and up to infinite frequency) oscillators are put into ε_{∞}. Different sets of oscillation parameters and ε_{∞} have been evaluated to get good matches to both the measured reflection spectrum in visible range (See FIG. 4(a)) and refractive index of bulk WS₂ in UV frequency range.

To further examing the accuracy of the fitting method, the inventors measured the refractive index of monolayer WS₂ film using standard spectral ellipsometry, and compared it to the refractive index obtained from the fitting of spectral reflection. The two sets of refractive index show nice consistence, with a difference of 0.3 and 0.2 in the real and imaginary parts around exciton resonance as indicated by FIG. 16.

TABLE 1
Parameters used in the calculation for the thermal equilibrium of neutral and charged excitons

| n_{+/-}(cm⁻²) | +8.1 × 10¹² | +4.5 × 10¹² | −9 × 10¹¹ | −6.5 × 10¹² | −10.3 × 10¹² | −13.7 × 10¹² |
|---|---|---|---|---|---|---|
| E_{A0} − E_{A+/-} (mev) | 23.0 | 13.0 | 24.0 | 37.0 | 53.0 | 65.0 |
| E_{F} (mev) | 20.8 | 11.6 | 3.0 | 20.7 | 32.8 | 43.6 |
| E_{b+/-} (mev) | 2.2 | 1.4 | 21 | 16.3 | 20.2 | 21.4 |

Note:
‘+’ denote hole doping and ‘−’ denote electron doping. The unit is meV. The binding energy of the charged A exciton can be calculated as E_{A0} − E_{A+/-} − E_{F}, where E_{A0} and E_{A+/-} are the optical bandgap of the neutral and charged A excitons, respectively. E_{F} is the fermi energy shift with respect to the minimum of conduction band caused by the injected charge carriers. It can be calculated from the charge density n and the density of state in 2D system as E_{F} = ℏ²πn/2m*. The effective electron mass 0.35m₀ and effective hole mass 0.46m₀ are used for calculating E_{F}. ^{S1} m₀ is the free electron mass. ⁴⁵

The present invention is described with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

It will be understood by those having skill in the art that, as used herein, a “transparent” material may allow at least some of an incident light to pass therethrough. In other words, transparent materials described herein need not be perfectly transparent and may have isotropic or dichroic absorption characteristics and/or may otherwise absorb some of an incident light.

Embodiments of the invention are described herein with reference to schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

### REFERENCES

1. Bennett, B. R.; Soref, R. A.; Alamo, J. A. D., Carrier-induced change in refractive index of InP, GaAs and InGaAsP. IEEE Journal of Quantum Electronics 1990, 26, 113.
2. Xu, F.; Das, S.; Gong, Y.; Liu, Q.; Chien, H.-C.; Chiu, H.-Y.; Wu, J.; Hui, R., Complex refractive index tunability of graphene at 1550 nm wavelength. Appl. Phys. Lett. 2015, 106, 031109.
3. Liu, M.; Yin, X. B.; Ulin-Avila, E.; Geng, B. S.; Zentgraf, T.; Ju, L.; Wang, F.; Zhang, X., A graphene-based broadband optical modulator. Nature 2011, 474 (7349), 64-67.
4. Soref, R.; Bennett, B., Electrooptical effects in silicon. IEEE Journal of Quantum Electronics 1987, 23, 123.
5. Xu, Q.; Schmidt, B.; Pradhan, S.; Lipson, M., Micrometre-scale silicon electro-optic modulator. Nature 2005, 435, 325.
6. Kuo, Y.-H.; Lee, Y. K.; Ge, Y.; Ren, S.; Roth, J. E.; Kamins, T. I.; Miller, D. A. B.; Harris, J. S., Strong quantum-confined Stark effect in germanium quantum-well structures on silicon. Nature 2005, 437 (7063), 1334-1336.
7. Seraphin, B. O.; Bottka, N., Franz-Keldysh Effect of the Refractive Index in Semiconductors. Physical Review 1965, 139 (2A), A560-A565.
8. Lettieri, S.; Maddalena, P., Nonresonant Kerr effect in microporous silicon: Nonbulk dispersive behavior of below band gap χ(3)(ω). Journal of Applied Physics 2002, 91 (9), 5564-5570.
9. Liu, A. S.; Liao, L.; Rubin, D.; Nguyen, H.; Ciftcioglu, B.; Chetrit, Y.; Izhaky, N.; Paniccia, M., High-speed optical modulation based on carrier depletion in a silicon waveguide. Opt Express 2007, 15 (2), 660-668.
10. Reed, G. T.; Mashanovich, G.; Gardes, F. Y.; Thomson, D. J., Silicon optical modulators (vol 4, pg 518, 2010). Nat Photonics 2010, 4 (9), 661-661.
11. Lee, E. J.; Choi, S. Y.; Jeong, H.; Park, N. H.; Yim, W.; Kim, M. H.; Park, J. K.; Son, S.; Bae, S.; Kim, S. J.; Lee, K.; Ahn, Y. H.; Ahn, K. J.; Hong, B. H.; Park, J. Y.; Rotermund, F.; Yeom, D. I., Active control of all-fibre graphene devices with electrical gating. Nat Commun 2015, 6.
12. Liu, Y.; Tom, K.; Wang, X.; Huang, C.; Yuan, H.; Ding, H.; Ko, C.; Suh, J.; Pan, L.; Persson, K. A.; Yao, J., Dynamic Control of Optical Response in Layered Metal Chalcogenide Nanoplates. Nano Lett 2016/01/13, 2016, pp 488-496.
13. Thareja, V.; Kang, J. H.; Yuan, H. T.; Milaninia, K. M.; Hwang, H. Y.; Cui, Y.; Kik, P. G.; Brongersma, M. L., Electrically Tunable Coherent Optical Absorption in Graphene with Ion Gel. Nano Lett 2015, 15 (3), 1570-1576.
14. Klein, J.; Wierzbowski, J.; Regler, A.; Becker, J.; Heimbach, F.; Müller, K.; Kaniber, M.; Finley, J. J., Stark Effect Spectroscopy of Mono- and Few-Layer MoS2. Nano Lett 2016, 16 (3), 1554-1559.
15. Yu, Y.; Yu, Y.; Cai, Y.; Li, W.; Gurarslan, A.; Peelaers, H.; Aspnes, D. E.; Walle, C. G. V. d.; Nguyen, N. V.; Zhang, Y.-W.; Cao, L., Exciton-dominated Dielectric Function of Atomically Thin MoS2 Films. Scientific Reports 2015, 5, 16996.
16. Chernikov, A.; van der Zande, A. M.; Hill, H. M.; Rigosi, A. F.; Velauthapillai, A.; Hone, J.; Heinz, T. F., Electrical Tuning of Exciton Binding Energies in Monolayer WS2. Physical Review Letters 2015, 115 (12), 126802.
17. Ross, J. S.; Wu, S.; Yu, H.; Ghimire, N. J.; Jones, A. M.; Aivazian, G.; Yan, J.; Mandrus, D. G.; Xiao, D.; Yao, W.; Xu, X., Electrical control of neutral and charged excitons in a monolayer semiconductor. Nat Commun 2013, 4, 1474.
18. Mak, K. F.; He, K.; Lee, C.; Lee, G. H.; Hone, J.; Heinz, T. F.; Shan, J., Tightly bound trions in monolayer MoS2. Nat. Mater. 2013, 12, 207.
19. Newaz, A. K. M.; Prasai, D.; Ziegler, J. I.; Caudel, D.; Robinson, S.; Haglund, R. F.; Bolotin, K. I., Electrical control of optical properties of monolayer MoS2. Solid State Commun 2013, 155, 49-52.
20. Liu, Q. H.; Li, L. Z.; Li, Y. F.; Gao, Z. X.; Chen, Z. F.; Lu, J., Tuning Electronic Structure of Bilayer MoS2 by Vertical Electric Field: A First-Principles Investigation. J Phys Chem C 2012, 116 (40), 21556-21562.
21. Liu, B.; Zhao, W.; Ding, Z.; Verzhbitskiy, I.; Li, L.; Lu, J.; Chen, J.; Eda, G.; Loh, K. P., Engineering Bandgaps of Monolayer MoS2 and WS2 on Fluoropolymer Substrates by Electrostatically Tuned Many-Body Effects. Adv. Mater. 2016, DOI: 10.1002/adma.201504876.
22. Wooten, F., Optical properties of solids. ACADEMIC PRESS New York and London: 1972.
23. Chuang, S. L., Physics of Optoelectronic Devices. John Wiley & Sons: New York, 1995.
24. Orfanidis, S. J., Electromagnetic Waves and Antennas. Rutgers University Press: Piscataway, N.J., 2008.
25. Beal, A. R.; Liang, W. Y.; Hughes, H. P., Kramers-Kronig analysis of the reflectivity spectra of 3R-WS 2 and 2H-WSe 2. Journal of Physics C: Solid State Physics 1976, 9 (12), 2449.
26. Li, Y.; Chernikov, A.; Zhang, X.; Rigosi, A.; Hill, H. M.; van der Zande, A. M.; Chenet, D. A.; Shih, E.-M.; Hone, J.; Heinz, T. F., Measurement of the optical dielectric function of monolayer transition-metal dichalcogenides: MoS2, MoSe2, WS2 and WSe2 Physical Review B 2014, 90 (20), 205422.
27. Chernikov, A.; Berkelbach, T. C.; Hill, H. M.; Rigosi, A.; Li, Y.; Aslan, O. B.; Reichman, D. R.; Hybertsen, M. S.; Heinz, T. F., Exciton Binding Energy and Nonhydrogenic Rydberg Series in Monolayer WS2. Phys. Rev. Lett. 2014, 113, 076802.
28. Gordon, R. G., Three Sum Rules for Total Optical Absorption Cross Sections. The Journal of Chemical Physics 1963, 38 (7), 1724-1729.
29. Tarucha, S.; Kobayashi, H.; Horikoshi, Y.; Okamoto, H., Carrier-Induced Energy-Gap Shrinkage in Current-Injection GaAs/AlGaAs MQW Heterostructures. Jpn. J. Appl. Phys. 1984, 23, 874.
30. Ugeda, M. M.; Bradley, A. J.; Shi, S. F.; da Jornada, F. H.; Zhang, Y.; Qiu, D. Y.; Ruan, W.; Mo, S. K.; Hussain, Z.; Shen, Z. X.; Wang, F.; Louie, S. G.; Crommie, M. F., Giant bandgap renormalization and excitonic effects in a monolayer transition metal dichalcogenide semiconductor. Nat Mater 2014, 13 (12), 1091-1095.
31. Berkdemir, A.; Gutierrez, H. R.; Botello-Mendez, A. R.; Perea-Lopez, N.; Elias, A. L.; Chia, C.-I.; Wang, B.; Crespi, V. H.; Lopez-Urias, F.; Charlier, J.-C.; Terrones, H.; Terrones, M., Identification of individual and few layers of WS2 using Raman Spectroscopy. Scientific Reports 2013, 3, 1755.
32. Gaur, A. P. S.; Sahoo, S.; Scott, J. F.; Katiyar, R. S., Electron-Phonon Interaction and Double-Resonance Raman Studies in Monolayer WS2. The Journal of Physical Chemistry C 2015, 119 (9), 5146-5151.
33. He, X.-F., Fractional dimensionality and fractional derivative spectra of interband optical transitions. Physical Review B 1990, 42 (18), 11751-11756.
34. Tanguy, C., Optical Dispersion by Wannier Excitons. Physical Review Letters 1995, 75 (22), 4090-4093.
35. Tanguy, C.; Lefebvre, P.; Mathieu, H.; Elliott, R. J., Analytical model for the refractive index in quantum wells derived from the complex dielectric constant of Wannier excitons in noninteger dimensions. Journal of Applied Physics 1997, 82 (2), 798-802.
36. Marquezini, M. V.; Tignon, J.; Hasche, T.; Chemla, D. S., Refractive index and absorption of GaAs quantum wells across excitonic resonances. Applied Physics Letters 1998, 73 (16), 2313-2315.
37. Lefebvre, P.; Christol, P.; Mathieu, H., Unified formulation of excitonic absorption spectra of semiconductor quantum wells, superlattices, and quantum wires. Physical Review B 1993, 48 (23), 17308-17315.
38. Lefebvre, P.; Christol, P.; Mathieu, H.; Glutsch, S., Confined excitons in semiconductors: Correlation between binding energy and spectral absorption shape. Physical Review B 1995, 52 (8), 5756-5759.
39. Ye, Z.; Cao, T.; O'Brien, K.; Zhu, H.; Yin, X.; Wang, Y.; Louie, S. G.; Zhang, X., Probing excitonic dark states in single-layer tungsten disulphide. Nature 2014, 513 (7517), 214-218.
40. Zhu, B.; Chen, X.; Cui, X., Exciton Binding Energy of Monolayer WS2. Scientific Reports 2015, 5, 9218.
41. A. Manassen, E. C., Arza Ron, E. Linder, and L. N. Pfeiffer, Exciton and trion spectral line shape in the presence of an electron gas in GaAs/AlAs quantum wells. Phys. Rev. B 1996, 54, 10609.
42. Ovchinnikov, D.; Allain, A.; Huang, Y. S.; Dumcenco, D.; Kis, A., Electrical Transport Properties of Single-Layer WS2. Acs Nano 2014, 8 (8), 8174-8181.
43. Yifei Yu; Yiling Yu; Chao Xu; Yong-Qing Cai; Liqin Su; Yong Zhang; Yong-Wei Zhang; Kenan Gundogdu; Cao, L., Engineering Substrate Interactions for High Luminescence Efficiency of Transition-Metal Dichalcogenide Monolayers. Adv. Func. Mater. 2016, DOI: 10.1002/adfm.201600418.
44. Huang, L. J.; Li, G. Q.; Gurarslan, A.; Yu, Y. L.; Kirste, R.; Guo, W.; Zhao, J. J.; Collazo, R.; Sitar, Z.; Parsons, G. N.; Kudenov, M.; Cao, L. Y., Atomically Thin MoS2 Narrowband and Broadband Light Superabsorbers. Acs Nano 2016, 10 (8), 7493-7499.
45. Leitao Liu, S. Bala Kumar, Yijian Ouyang, and Jing Guo Performance Limits of Monolayer Transition Metal Dichalcogenide Transistors. IEEE Trans. Electron Devices, 58, 3042-3047 (2011).

In the drawings and specification, there have been disclosed embodiments of the disclosure and, although specific terms are employed, they are used in a generic and descriptive sense only and not for purposes of limitation.

1. A method of electrically controlling photons using atomically thin transition metal dichalcogenide layer.

2. The method of claim 1, further comprising applying an electrical field to the transition metal dichalcogenide layer.

3. The method of claim 2, wherein applying the electrical field to the transition metal dichalcogenide layer comprises connecting a first electrode and a second electrode to a voltage source, and
wherein the first electrode is electrically isolated from the transition metal dichalcogenide layer by an insulation layer that extends between the first electrode and the transition metal dichalcogenide layer, and the second electrode is electrically connected to the transition metal dichalcogenide layer.

4. The method of claim 1, further comprising injecting charge carriers into the transition metal dichalcogenide layer.

5. The method of claim 1, wherein the transition metal dichalcogenide layer comprises MoS₂, WS₂, WSe₂, MoSe₂, MoTe₂, WTe₂, and/or an alloy thereof.

6. The method of claim 1, wherein the transition metal dichalcogenide layer comprises a monolayer or mutilayers including less than or equal to 10 layers.

7. A photonic device comprising:
a transition metal dichalcogenide layer;
a first electrode and a second electrode on the transition metal dichalcogenide layer, the second electrode being electrically connected to the transition metal dichalcogenide layer; and
an insulation layer extending between the first electrode and the transition metal dichalcogenide layer thereby electrically isolating the first electrode from the transition metal dichalcogenide layer.

8. The device of claim 7, wherein the transition metal dichalcogenide layer comprises a monolayer or mutilayers including less than or equal to 10 layers.

9. The device of claim 7, wherein the transition metal dichalcogenide layer comprises MoS₂, WS₂, WSe₂, MoSe₂, MoTe₂, WTe₂, and/or an alloy thereof.

10. The device of claim 7, wherein the second electrode directly contacts the transition metal dichalcogenide layer.

11. The device of claim 7, wherein the transition metal dichalcogenide layer comprises a first surface and a second surface opposite the first surface, and
wherein the first electrode is on the first surface of the transition metal dichalcogenide layer, and the second electrode is on the second surface of the transition metal dichalcogenide layer.

12. (canceled)

13. The device of claim 7, wherein the transition metal dichalcogenide layer comprises a first surface and a second surface opposite the first surface, and
wherein both the first electrode and the second electrode are on the first surface of the transition metal dichalcogenide layer.

14. (canceled)

15. The device of claim 7, wherein the transition metal dichalcogenide layer comprises a first surface and a second surface that is opposite the first surface and is configured to be exposed to an incident light, and
wherein the device further comprises a reflection layer on the first surface of the transition metal dichalcogenide layer.

16. The device of claim 15, wherein the reflection layer comprises an insulating reflection layer and a conductive reflection layer sequentially stacked on the first surface of the transition metal dichalcogenide layer.

17. The device of claim 15, wherein the first electrode is between the transition metal dichalcogenide layer and the reflection layer.

18. (canceled)

19. A tunable waveguide comprising:
a waveguide;
a first electrode and a second electrode on the waveguide;
a transition metal dichalcogenide layer extending between the waveguide and the first and second electrodes, the transition metal dichalcogenide layer being electrically connected to the second electrode; and
an insulation layer extending between the first electrode and the transition metal dichalcogenide layer thereby electrically isolating the first electrode from the transition metal dichalcogenide layer.

20. The tunable waveguide of claim 19, wherein the first electrode and the second electrode are spaced apart from each other along a longitudinal direction of the waveguide.

21. The tunable waveguide of claim 19, wherein the transition metal dichalcogenide layer comprises a monolayer or mutilayers including less than or equal to 10 layers.

22. The tunable waveguide of claim 19, wherein the transition metal dichalcogenide layer comprises MoS₂, WS₂, WSe₂, MoSe₂, MoTe₂, WTe₂, and/or an alloy thereof.

23. The tunable waveguide of claim 19, wherein the second electrode directly contacts the transition metal dichalcogenide layer.
